(19) United States
(12) Patent Application Publication
(10) Pub. No.: US 2007/0299975 A1
(43) Pub. Date: Dec. 27, 2007

(54) Systems and methods for migrating data

(76) Inventors: Klaus Daschakowsky, Bad Schoenborn (DE); Dirk Frauenfeld, Plankstadt (DE); Peter Schlieper, Muehlhausen (DE)

Correspondence Address: SAP / FINNEGAN, HENDERSON LLP, 901 NEW YORK AVENUE, NW, WASHINGTON, DC, 20001-4413, US

(21) Appl. No.: 11/798,727

(22) Filed: May 16, 2007

Related U.S. Application Data
(60) Provisional application No. 60/800,427, filed on May 16, 2006.

(51) Int. Cl. G06F 15/16

(52) U.S. Cl. 709/228

(57) ABSTRACT

The present invention provides systems and methods for migrating data from at least one data source to at least one data target according to one or more migration objects or migration rules. The migration rules, for example, may control how the data migration is done. For instance, the migration rules may describe how the source data may be modified during the migration process to meet the requirements of the target system. In exemplary embodiments, a neutral interface is provided which comprises a mapping of external data fields to business objects located on the target system.

### CROSS-REFERENCE TO RELATED APPLICATION

This application is related to and claims the benefit of priority under 35 U.S.C. §119(e) to U.S. Provisional Patent Application No. 60/800,427, entitled “Systems and Methods for Migrating Data,” filed May 16, 2006, the disclosure of which is expressly incorporated herein by reference to its entirety.

### DESCRIPTION OF THE INVENTION

1. Field of the Invention

The present invention relates to systems and methods for migrating data from a data source to a data target. More particularly, the present invention relates to systems and methods for migrating data from at least one data source to at least one data target according to one or more migration rules, where the migration rules indicate how the data migration may be done.

2. Background of the Invention

Data migration may generally refer to the process of transferring data from one format and/or computer system to another format and/or computer system. As used herein, the term “format” may concern the representation of the data and/or the data model. Data migration may be applied when organizations decide to use new computing systems or database management systems that are incompatible with the current systems. Further, data migration may be necessary when organizations change their computer systems by upgrading existing computer systems to new computer systems.

Typically, custom conversion software may be created or programmed to move and convert data from a first (source) computer system to a second (target) computer system. Further, available conversion software may use import interfaces of the target system. These import interfaces, however, often do not cover the full scope of the business objects of the target system. Further post processing steps may thus be necessary to convert the moved data. Finally, existing migration tools that move data from operational databases to data warehouses, usually do not provide the flexibility and customization normally desired.

### SUMMARY OF THE INVENTION

Systems and methods consistent with the invention may migrate a business object from a source to a target. For example, the system may comprise a migration object associated with the business object, where the migration object is used to control the conversion of source data at the source to target data at the target. The source data may reflect the business object. The system may also include a migration program that may migrate the source data to the target according to the migration object.

According to another aspect of the invention, a set of migration objects for use with a data migration system is provided. The migration system may migrate a business object from a source to a target. Each migration object may comprise data which identifies the business object, a definition of the source data describing the business object, a definition of the target data describing the business object, and at least one migration rule which specifies the migration of the source data into the target data.

Other objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate various embodiments and aspects of the invention and, together with the description, explain the principles of the invention. In the drawings:

FIG. 1 illustrates an exemplary embodiment of a migration system consistent with the invention;

FIG. 2 illustrates an exemplary migration process consistent with the invention;

FIG. 3 illustrates an exemplary flow diagram of an embodiment consistent with the invention;

FIG. 4 illustrates an exemplary sequence diagram of a data migration process consistent with the invention; and

FIG. 5 illustrates an exemplary data migration of a data record consistent with the invention.

### DESCRIPTION OF THE EMBODIMENTS

The following description refers to the accompanying drawings. Wherever possible, the same reference numbers will be used throughout the drawings to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

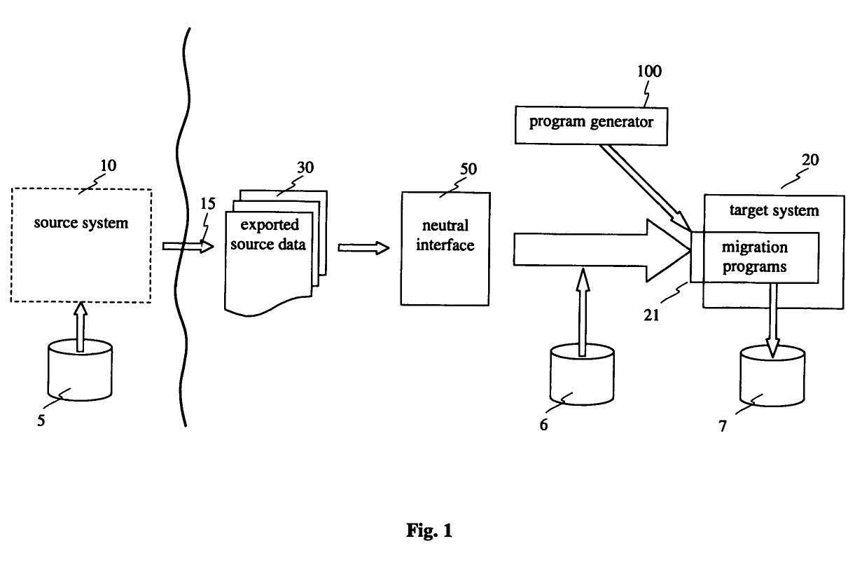

FIG. 1 shows an exemplary embodiment of a migration system consistent with the present invention. As used herein, the term “data migration” or “migration” generally refers to a process of transferring data from one format and/or computer system to another format and/or computer system. As shown in FIG. 1, an exemplary migration system may include databases 5-7, a source system 10, a target system 20, and a neutral interface 20. One task during a migration process may be the transfer of data (e.g. business data, such as purchase orders or customer master data), from an existing computer system (source system 10) to a new computer system (target system 20). Since in many cases the data structures of source system 10 may be different from the data structures of target system 20, a data transfer may also include conversion of the data from the source data format into the target data format. As used herein, this conversion may be referred to as a mapping or other type of transformation.

To support a migration process that may be independent of source system 10, exemplary migration systems consistent with the invention may include neutral interface 50. Neutral interface 50 may comprise one or more defined data structures, denoted as source data definitions. For example, neutral interface 50 may provide a source data definition for, for example, customer master data comprising a unique identifier, such as the name and address of a customer. In one exemplary embodiment, source data definitions may be stored as flat files, structured files, XML data files, an XML scheme, or as a data repository.

Database 5 may store source data. The source data stored in a database 5 may be transferred from source system 10 to target system 20 by using the defined data structures of neutral interface 50. Transferred data may then be stored in database 7 located with target system 20. Thus, a data migration may be possible even though source system 10 and target system 20 are part of different enterprises.

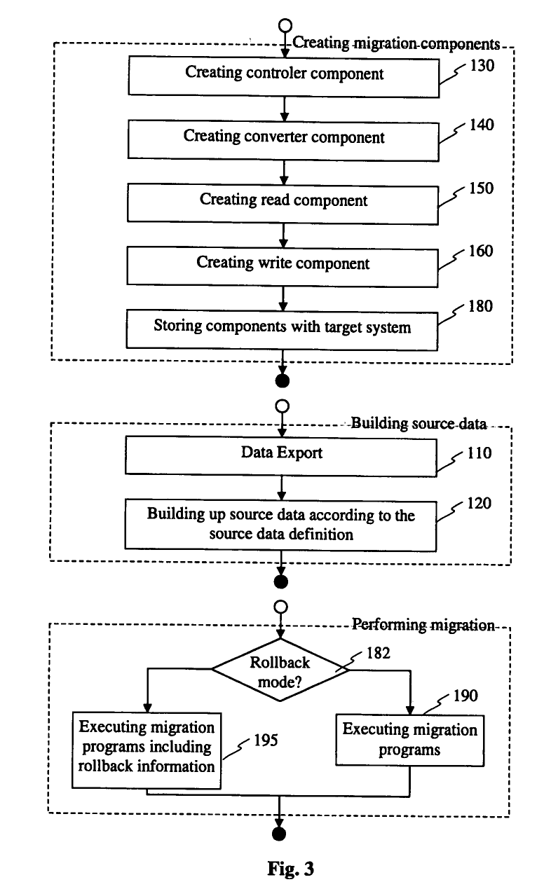

As part of a data migration, the source data may be exported (arrow 15) from source system 10 into one or more data files 30. The structures of the data files 30 may correspond to one of the defined data structures provided by neutral interface 50. Data files 30 may be stored as flat files, structured files, XML data files, or within a database. A program generator 100 may create, within target system 20, a number of migration programs 21 that may transfer the exported source data 30 to target system 20. Program generator 100 may start migration programs 21 immediately or after a delay. During a transfer, migration programs 21 may modify exported data 30 according to a number of migration rules, which may be stored in database 6. As used herein, migration programs 21 may also be denoted as migration components. Exemplary migration components 21 are described in more detail below in connection with FIG. 3.

Returning to FIG. 1, source system 10, the source data definitions, the migration rules, program generator 100, and target system 20 may be located physically with different computer systems. For example, data sources may be located with a first sub system, while source data definitions, migration rules and a program generator may be located with a second sub system. Target data may be further located with a third sub system. In one embodiment, the sub systems may be connected by a communication network (not shown). In a further embodiment, a data source, source data definitions, migration rules, and a program generator and data target may be located with the same computer system.

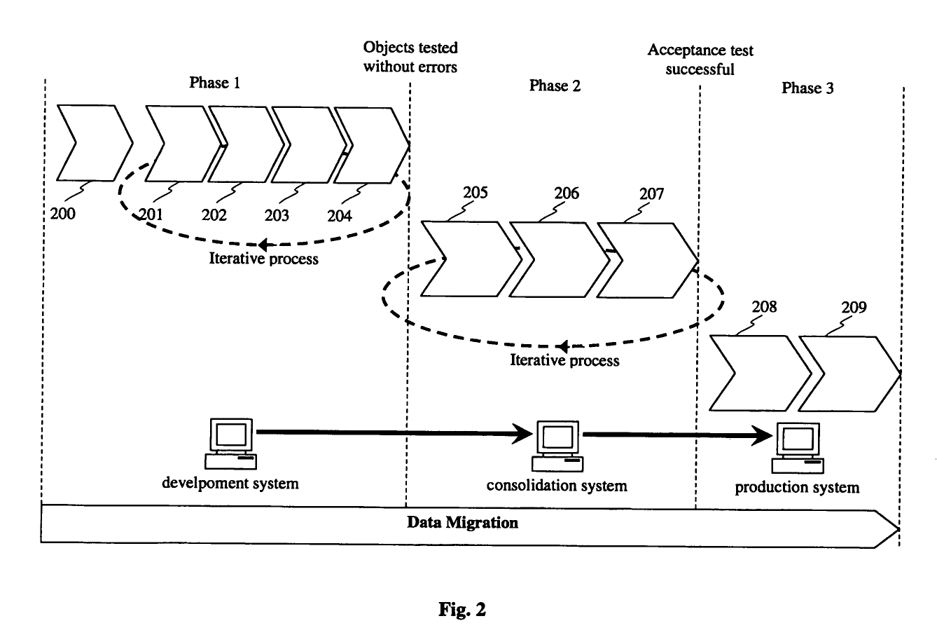

FIG. 2 shows an exemplary timeline of a migration process according to an exemplary embodiment consistent with the invention. As shown in FIG. 2, a data migration timeline may be subdivided into three migration phases, starting with migration phase 1. During the first migration phase 1, which may be carried out by a development system, the migration steps 200 to 204 may be executed. Step 200 may comprise selecting the migration objects based on the business objects to be migrated. Each migration object may comprise the respective source data definition, a number of predefined migration rules, and the target data definitions. For example, a customer may select the migration object “MATERIAL DATA”. The migration object MATERIAL DATA may thus represent the business object MATERIAL DATA and a set of predefined migration rules according to the business object.

Systems consistent with the invention may provide a number of predefined migration rules. A migration rule may provide at least one migration variant. A migration variant, in turn, may comprise predefined program code adapted to modify source values according to the requirements of the target data fields of target system 20. In exemplary implementations, the predefined program code may be ready to use and, thus, a customizing of the program code may not be necessary. Returning to FIG. 2, within step 201, if one or more migration objects do not satisfy one or more customer requirements (e.g. if the standard migration variant of a migration rule does not satisfy the customer requirements), the migration rule variants of the respective migration rule may then be selected according to the customer requirements.

Step 202 may comprise rule adaptation. For instance, rule adaptation of the migration objects may be executed by mapping source data fields to target data fields. Mapping may also include assigning a migration rule per target data field. Further, if no migration rule is currently assigned to a target data field, a new migration rule may be created or an existing migration rule can be used and assigned to the target data field. The existing migration rule can be adapted according to the customer requirements. During execution of the data migration, the values of the source data fields may be converted according to the assigned migration rules and stored as migrated values into the target data fields.

Exemplary migration variants which may be provided by the migration systems are:

MOVE (1-to-1 data transfer)—the source value will be transferred from the source field to the target field without any modification;

VALUE MAPPING—the source value will be transferred from the source field to the target field by replacing the source value with a predefined target value;

INIT—initializing the target field with a predefined value if the source field is empty or the source field does not exists. For example, if target data requires the country code of a customer but the source data associated with the customer does not provide the country code, then the INIT variant assigns a predefined country code to the target field; and

DOMAIN RULE—data fields of similar type are migrated uniformly and consistently according to a centrally stored migration rule.

During rule adaptation or rule customizing, further custom migration variants may be added to the migration rule. One example of such a migration variant may be concatenating the source value with a predefined suffix or prefix or a custom program/program code for more complex operations. In one embodiment, customizing of predefined rules or specifying of new rules and/or migration variants may be supported by the development system. The development system may provide functionality such as storing and restoring customized migration rules or migration variants.

If a migration rule provides more than one migration variant, the respective migration variant can be selected during step 202. In one embodiment of the invention, the variant MOVE may be the standard migration variant.

Step 203 may perform a data import of data which is to be transferred from source system 10 to target system 20. During the import, the exported source data may be converted into an internal data representation. The conversion into an internal data representation may provide the advantage of greater efficiency for the processing of the data. In exemplary embodiments, due to the internal data representation, the data processing can be performed independently of source system 10 and target system 20. Within step 204, a test of the migration project may be carried out by testing all conversion objects using an amount of data. Such conversion objects may be typical business objects, such as customer master data, sales orders, or material master data. The steps 201 to 204 may be repeated iteratively until no more errors occur during the test.

After step 204, the first migration phase 1 may finish and the migration process can be continued with the second migration phase 2. Migration phase 2 may start with step 205 by performing a full volume data migration within the consolidation system. All data which is to be transferred from source system 10 to target system 20 may be migrated object-wise according to the migration customizing defined in migration phase 1. The migration within step 205 may be done by using the data in the internal data representation.

Within the next process steps 206 and 207, the migrated data may be validated object-wise, and an acceptance test may be performed. Migration phase 2 may be repeated iteratively until no more errors occur. During migration phase 2, systems consistent with the invention may still modify the migration customizing. If object-wise validation and acceptance test are successful, the migration may be ready to be performed with the production system in migration phase 3.

In migration phase 3, a productive data migration 208 may be performed and a final validation 209 may be carried out. Typically, steps 208 and 209 are performed with the production system which may correspond to target system 20. After the successful validation 209, all of the source data may be available at target system 20.

In a further embodiment, the steps 200 to 204 of phase 1 and the steps 205 to 207 of phase 2 may be carried out on a single system, which may be a test system. Thereby, a full copy of the production system may be made on which steps 200 to 207 are carried out. After the successful acceptance test, the migration may be transported into the actual production system where the steps 208 and 209 may be executed, as described above, based on the transported migration.

FIG. 3 shows an exemplary flow diagram of an embodiment consistent with the present invention. As shown in FIG. 3, building source data (steps 110, 120), creating migration components (steps 130 to 180) and performing migration (steps 182 to 195) may be performed separately from one another, such as at different times. However, alternative embodiments may include performing one or more of these steps at the same time. Further, building source data, creating migration components, and performing migration may be performed on different computer systems.

Referring to FIG. 3, a data export 110 may be done. This may include exporting the data to be migrated from source system 10 into a number of export files 30, where the structure of the export files corresponds to the source data definitions provided by, for example, neutral interface 50. In exemplary implementations, the export may be performed by using third party export tools or custom export programs. Of course, export mechanisms provided by source system 10 can also be used. In one embodiment, the export files may be XML data files.

In a further embodiment, data is exported into export files, where the structure of the export files is different from the source data definitions. In this case, the export files are converted, step 120, into the corresponding structure. The result of step 110 and optional step 120 is a number of export files comprising data according to the source data structure provided by neutral interface 50. Data export may be performed on the computer system where the source data or source system 10 is located. It is also possible that the export tools are running on a different computer system provided that the export tools have access to source system 10 to read and export the source data.

The next process comprises generation of migration programs 21 (or migration components) by program generator 100. For instance, by using the information about the customizing of the migration as described above, program generator 100 may create several programs 21 or components to perform the data transfer and data conversion. In an exemplary embodiment of the invention, migration components 21 may comprise at least a controller component, a read component, a write component, and a converter component. Step 130 may thus create a controller component. The controller component may control the data migration and monitor the processing. The controller component may also control parallel processing of data. Further, the controller component may trigger a restart of data migration. A restart of data migration may be necessary if, during the data migration, an error occurs. Such an error may, for example, be an interruption of the communication link between the system running the migration programs and the computer system storing the source data. It is also possible to restart a data migration at the last valid data position. Thus, systems consistent with the invention may avoid re-migrating data that was already successfully migrated. Step 140 may create the converter component which may perform the conversion of the data to be migrated according to the migration rules as described above. Step 150 may create the read component which may read the exported data according to the source data definition and may convert those into the internal data representation. This conversion may be referred to herein as technical conversion. Step 160 may create a write component. The write component may transfer the data from the internal representation to the target representation and may trigger the import of the data into target system 20. Systems consistent with the invention may generate the above components in any time sequence. Moreover, systems consistent with the invention may use more or less of the above components. In the following step 180, the created migration components may be stored within target system 20 where the migration may be executed.

The next process may perform the data migration. Systems consistent with the invention may perform data migrations in a rollback mode. If the system is running in the rollback mode, the migrated data may be marked as deletable. In this way, a data migration can be performed, and afterwards the migrated data can be removed without impacting target system 20. For each inserted data record, a respective delete-record may be stored within target system 20. A delete-record may comprise at least a unique identifier, such as a Run ID, that identifies the conversion object, as well as a delete function for removing the respective data record from the target system.

If an error occurs during the migration, or the migration customizing does not correspond to the customer requirements, the whole data migration can be revoked by removing the inserted data records according to the stored delete-records. Therefore, the iterative process of migration phase 2, as shown on FIG. 2, can be performed multiple times without the need of re-setting up the basic system, such as the consolidation system. After removing the migrated data, the delete-records may also be removed from the system.

Step 182 may determine whether or not the rollback mode may be set for the current data migration. If it is, the process may continue with step 195 by performing the data migration in the rollback mode. For example, in addition to storing the data records, rollback information such as the delete-records described above may also be stored in target system 20. If the rollback mode is not set, step 190 may be performed by executing the migration programs without storing such rollback information.

Systems consistent with the invention may provide for a test mode (not shown in FIG. 3). If the data migration is running in the test mode, the write operations on the storage device may not be performed. This may be useful, for example, during the migration customizing in phase 1.

According to exemplary embodiments of the inventive system, for each conversion object, a set of specialized components (controller, converter, read, and write) may be created. In exemplary embodiments, the concept of creating specialized components for each conversion object may leads to better migration performance, as compared to a generic program as used in known migration tools.

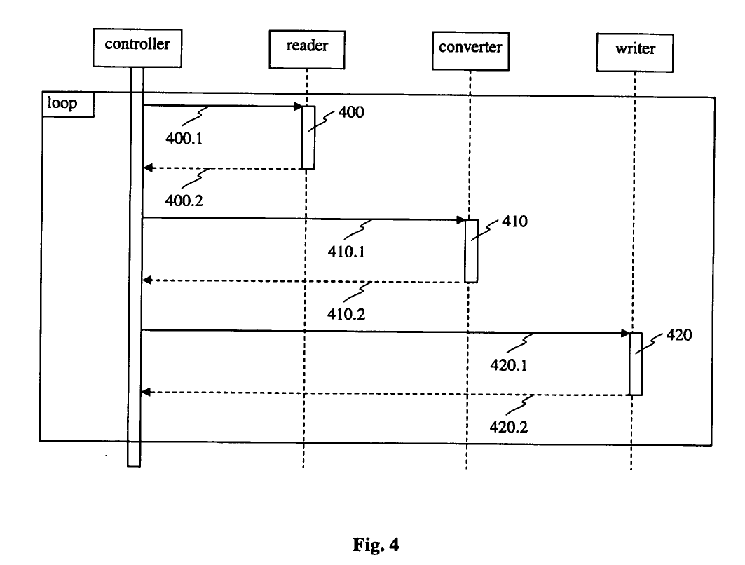

FIG. 4 shows an exemplary sequence diagram of the migration components according to a migration process consistent with the invention. As illustrated in FIG. 4, the controller may first determine a portion of the exported data to be migrated. The controller may trigger 400.1 the read component and pass the information about the exported data portion to the read component. The read component may then read 400 the respective portion of the exported data according to the source data definition and convert 400 the data into an internal representation. The read component may then pass 400.2 the control back to the controller.

The controller may then trigger 410.1 the converter component, which may perform the data conversion 410 according to the migration rules. If the conversion is finished, the converter component may pass 410.2 the control back to the controller.

The controller may then trigger 420.1 the write component, which may perform the import 420 of the converted data portion and pass 420.2 the control back to the controller. If there is further exported data which is to be migrated, the controller may determine the next exported data portion and retrigger the read component. The sequence of reading-converting-writing may thus be repeated until no more exported data exists to be migrated.

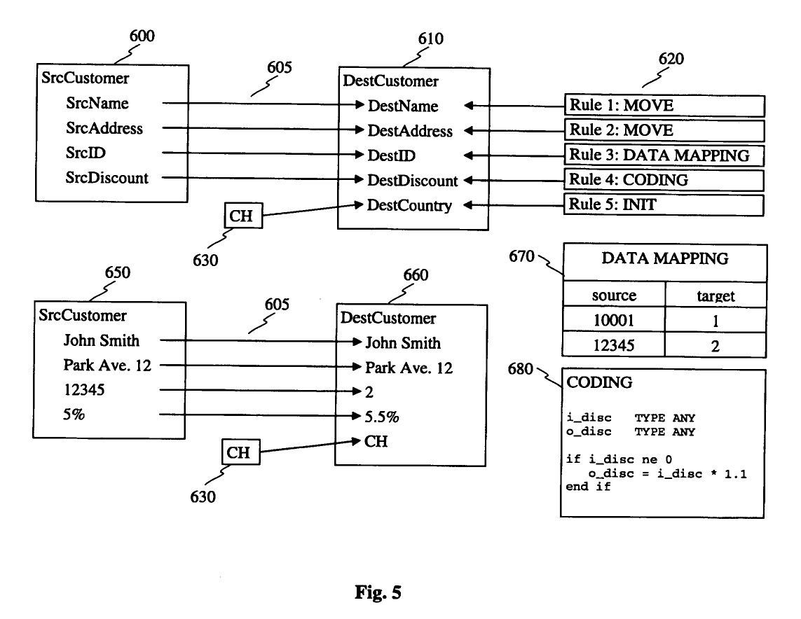

FIG. 5 illustrates an exemplary data migration of a customer data record. Item 600 shows the data structure of migration object CUSTOMER according to the source data definition provided by neutral interface 50. As shown in FIG. 5, data structure 600 may comprise the data fields SrcName, SrcAddress, SrcID, and SrcDiscount. In a further embodiment, data structure 600 may comprise a plurality of different data structures. For example, the data fields SrcName and SrcAddress may be part of a first data structure and the data fields SrcID and SrcDiscount may be part of a second data structure. Systems consistent with the invention may also provide a receiver driven approach for defining mappings of source data fields to target data fields. With the receiver driven approach, the source data fields may be determined according to the target data fields.

Item 610 shows the target data structure of the migration object CUSTOMER comprising the data fields DestName, DestAddress, DestID, DestDiscount and the additional field DestCountry. The mappings of the source data fields to the target date fields are depicted as arrows 605. As shown, all source data fields may be mapped to the respective target data fields. In the exemplary illustration, target data field DestCountry does not exist. Accordingly, any source data field and all the customers are located in Switzerland, the target data field DestCountry is filled by the initialization value CH 630 according to the Rule 5 (INIT).

The items 620 show the migration rules assigned to the respective target data fields. Rule 1 and Rule 2 (MOVE), for example, indicate that a simple 1-to-1 data transfer should be performed. Rule 3 (DATA MAPPING) indicates that the source values should be mapped. For instance, the source values may be converted to target values according to the mapping table 670 described below. According to the mapping table 670, a source value of 12345 may be converted to the target value of 2.

Rule 4 (CODING) indicates that data transfer from the source field SrcDiscount to target field DestDiscount may be carried out by using a custom program code. Item 680 illustrates the custom program code of this migration rule. As illustrated, the target field DestDiscount may be filled with the source field by multiplying SrcDiscount by 1.1 and only if DestDiscount is not equal to 0.

Items 650 and 660 show a source data record and the respective target data record after the migration has been performed. As can be seen, the source values are transferred and converted from the source fields to the target fields according to the migration rules 620.

The computer systems or distributed computer networks as mentioned above may be used, for example, for producing goods, delivering parts for assembling products, controlling technical or economical processes, or implementing telecommunication activities. To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical or text user interface through which computer programs interact with users.

A computer may include a processor, memory coupled to the processor, a hard drive controller, a video controller and an input/output controller coupled to the processor by a processor bus. The hard drive controller is coupled to a hard disk drive suitable for storing executable computer programs, including programs embodying the present technique. The I/O controller is coupled by means of an I/O bus to an I/O interface. The I/O interface receives and transmits in analogue or digital form over at least one communication link. Such a communication link may be a serial link, a parallel link, local area network, or wireless link (e.g. an RF communication link). A display is coupled to an interface, which is coupled to an I/O bus. A keyboard and pointing device are also coupled to the I/O bus. Alternatively, separate buses may be used for the keyboard pointing device and I/O interface.

For purposes of explanation only, certain aspects and embodiments are described herein with reference to the components illustrated in FIGS. 1-5. The functionality of the illustrated components may overlap, however, and may be present in a fewer or greater number of elements and components. Further, all or part of the functionality of the illustrated elements may co-exist or be distributed among several geographically dispersed locations. Moreover, embodiments, features, aspects and principles of the present invention may be implemented in various environments and are not limited to the illustrated environments.

Further, the sequences of events described in or with respect to FIGS. 1-5 are exemplary and not intended to be limiting. Thus, other method steps may be used, and even with the methods depicted in FIGS. 1-5, the particular order of events may vary without departing from the scope of the present invention. Moreover, certain steps may not be present and additional steps may be implemented in FIGS. 1-5. Also, the processes described herein are not inherently related to any particular apparatus and may be implemented by any suitable combination of components.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system for migrating a business object from a source to a target, the system comprising:
a migration object associated with the business object, where the migration object is used to control the conversion of source data at the source to target data at the target, wherein the source data reflects the business object; and
a migration program to migrate the source data to the target according to the migration object.

2. The system of claim 1, wherein the migration object comprises:
data identifying the associated business object;
a definition of the source data which describes the business object;
a definition of the target data which describes the business object; and
at least one migration rule which specifies migration of the source data describing the business object into the target data describing the business object.

3. The system of claim 2, wherein migrating the source data includes applying the migration rule to the source data.

4. The system of claim 2, wherein the source data definition is stored in one of a flat file, a structured file, an XML scheme, a data repository and an XML data file.

5. The system of claim 2, wherein a migration rule includes at least one of:
a mapping of source data fields to target data fields, or
a conversion of source data values to target data values.

6. The system of claim 1, further comprising a controller program which triggers and controls the migration program.

7. The system of claim 1, further comprising a program generator adapted to generate the migration program.

8. The system of claim 1, wherein the migration programs comprise executable binary programs and interpretable program code.

9. The system of claim 1, wherein the target is one of a database, a flat file, a structured file, an XML data file, a data container, a message, a service, and a software application.

10. The system of claim 1, further comprising:
means for flagging migrated data stored at the target; and
means for removing the flagged data from the target.

11. A method for migrating a business object from a source to a target, the method comprising:
selecting, based on the business object to be migrated, a migration object used to control a conversion of source data at the source to target data at the target, wherein the source data reflects the business object; and
generating, based on the selected migration object, a program which migrates the source data to the target according to the migration object.

12. The method of claim 11, wherein the migration object comprises:
data identifying the associated business object;
a definition of the source data which describes the business object;
a definition of the target data which describes the business object; and
at least one migration rule which specifies migration of the source data describing the business object into the target data describing the business object.

13. The method of claim 12, wherein migrating the source data includes applying the migration rule to the source data.

14. The method of claim 12, wherein a migration rule includes at least on of:
a mapping of source data fields to target data fields, or
a conversion of source data values to target data values.

15. The method of claim 12, wherein the source data definition is stored in one of a flat file, a structured file, an XML scheme, a data repository and an XML data file.

16. The method of claim 11, wherein the target is one of a database, a flat file, a structured file, an XML data file, a data container, a message, a service, and a software application.

17. The method of claim 11, further comprising:
flagging migrated data stored at the target; and
removing the flagged data from the target.

18. A set of migration objects for use with a data migration system may migrate a business object from a source to a target, each migration object comprising:
data which identifies the business object;
a definition of the source data describing the business object;
a definition of the target data describing the business object; and
at least one migration rule which specifies the migration of the source data into the target data.

19. The migration objects of claim 18, wherein the at least one migration rule modifies the source data during the migration.

20. The migration objects of claim 18, wherein the at least one migration rule defines a transformation from the source data to the target data based on the source data definition and the target data definition.
